(19) United States
(12) Patent Application Publication
(10) Pub. No.: US 2005/0218068 A1
(43) Pub. Date: Oct. 6, 2005

(54) Filter cartridge

(76) Inventors: Makoto Komatsu, Kanagawa (JP); Kunio Fujiwara, Kanagawa (JP); Kazuyoshi Takeda, Kanagawa (JP); Yukio Hashimoto, Tokyo (JP); Eriko Usui, Tokyo (JP); Mutsuhiro Amari, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/505,418

(22) PCT Filed: Feb. 27, 2003
(86) PCT No.: PCT/JP03/02232

§ 371 Date: May 12, 2005

(30) Foreign Application Priority Data
Feb. 27, 2002 (JP) 51298/2002
Feb. 27, 2002 (JP) 51290/2002

(51) Int. Cl. B01D 71/06

(52) U.S. Cl. 210/500.27; 210/502.1; 210/504; 210/505

(57) ABSTRACT

The present invention has an object to provide a filter cartridge for purifying a chemical which can efficiently remove metal ions and impurities in the form of fine particles in a liquid to be filtered. The present invention provides, as the means to achieve the above described object, a filter cartridge comprising a fiber membrane material obtained by introducing ion exchange groups and/or chelate groups into an organic polymer fiber membrane base material having an average fiber diameter of 0.1 μm to 20 μm and an average pore size of 1 μm to 20 μm or a filter cartridge. And also present invention provides, as the means to achieve the above described object, comprising a bi-layered or laminated structure of filter membranes prepared from fiber membrane material obtained by introducing ion exchange groups and/or chelate groups into an organic polymer fiber membrane base material and a micro porous membrane material.

### TECHNICAL FIELD

The present invention relates to a filter cartridge which can particularly preferably be used in the purification of pure water, a chemical or organic solvent to be used in the semiconductor industry. Particularly, the present invention relates to a filter cartridge, which can remove various forms of trace amounts of metal impurities, for example ionic, colloidal or fine particle, from ultra pure water or chemicals such as photoresists, thinners or an organic solvent.

In recent years, with the advancement of the semiconductor production technology, the technology requirement of large scale integration of semiconductor devices and the reduction of technology node going smaller make progress rapidly even before. In keeping with the speed of this progress, the cleanliness level of chemicals to be used in the microelectronics device fabrication process such as photoresist, thinner, photoresist developer, photoresist stripper, ultrapure water or organic solvents must be controlled and kept extremely pure level. For example, a particle level and ionic contamination level for critical metals are particularly important. According to ITRS 2000 (International Technology Roadmap for Semiconductors 2000), it is reported that the DRAM ½ Pitch size is estimated to be 130 nm in 2003 and 100 nm in 2005. Namely, in the near future it will be required that the removal of particles with ½ pitch size or larger from the chemicals described above. In addition, it is stated that the critical metal contamination level on device would be 2×10⁹ atoms/cm² in 2005. As of this circumstance, the advancement of the microelectronics fabrication technology, the product performance and yields must depend on the advancement of purification technology for the chemicals. It is essential to achieve the level with respect to the particles and the metal contamination in the chemicals, in consideration of the continuous growth hereafter in the semiconductor industry.

At present, the mainstream of the production tools of semiconductor devices is an integrated system capable of conducting multiple process on a single apparatus. The integration and complexity of the tools including piping are highly crowded and the hurdle of size restrictions and requirements in the process capabilities of the each process device get higher and higher, for example, the requirements of its capability to process high flow rate of fluids with small size units became very important. Contrary to this, with the development of the recent high resolution and high sensitivity photoresists, the composition became more complex and photosensitive compounds and acid generators became more sensitive against small changes in an environment. As a consequence—with respect to the chemical such as a photoresist it is necessary to remove impurities/decomposed substances and the like therefrom immediately before use (at the point of use, at POU), by, for example, conducting filtration process just before applying the chemical to the surface of wafer.

Thus, although the requirement for the impurity removal technique for the chemicals to be used in the semiconductor industry has become very critical, as the chemical purification technique which can be conducted at POU in the semiconductor device fabrication process, filtration is practically the only method. In other words, the development of a filtration technology that can achieve a desired cleanliness level of chemicals by removing impurities such as metal ion with desired efficiency by one-step operation and undersize filtration device is strongly longed for.

As the method of removing trace amounts of metal impurities in a chemical, the method that has been most generally employed heretofore is the use of an ion exchange resin with sphere shaped beads, having highly developed micro porous structure on the surface hold large surface area therein and contain large amounts of ion exchange groups on the pore surface that absorb metal impurities thereon. These resins have around 0.5 mm as diameter, and are used with filled in a column and allowing a process fluid to flow therethrough. In such a system, fluid convection occurs only around out side of the spherical surface of the resin, in order the ion exchange reaction to take place, metal ion needs to self-diffuse within a micro pore where the fluid are stagnant and ion exchange groups are, until that meet the ion exchange group. In this mechanism, the ion removal performance of the resin units changes depending on the ratio of fluid velocity and diffusion rate of metal ions, therefore, with a low fluid velocity, the ion removal ratio per unit volume is more improved. On the other hand, however, a large unit volume will be necessary to obtain the cleanliness level and fluid volume can process per time which microelectronics device fabrication process requires. It is not practical to ion exchange resin liquid purification system to be applied to fabrication tools at POU. Further, in the case of purification of organic solvent, the metal removal efficiency decline drastically compared to water. It is because that the ion exchange resin consists of styrene and divinylbenzene cross-linked structure allows the swelling of organic solvent into the structure and intrigue the closure of the micro pores where ion exchange groups are on. Consequently, metal ions can not reach to the functional group to be absorbed, therefore, considerable reduction occurs in the metal removal performance, and thus practically impossible to develop a purification system with ion exchange resin for the purpose described above. Further, in order to conduct high efficiency metal removal, a preparation method of a composite functional membrane obtained by modifying with an ion exchange resin on a filter medium is proposed. With this method, the effect of a zeta potential on the membrane media is increased. Also in this case, due to the use of an ion exchange resin as ion exchange medium, the above restrictions could not overcome.

As the purifier material which solves these problems of resin adsorbents, the method to obtain high performance membranes by introducing functional groups such as ion exchange groups or chelate groups onto a surface of micro porous membrane by graft polymerization are proposed. These membranes are useful to remove fine particles in a liquid in addition to a function of removing metal ion by absorbing with the functional groups introduced by graft polymerization. Further, comparing the transport mechanism against ion exchange resin system, for graft membrane, the ion exchange groups lies on the surface of micro pores where the fluid convection directory occurs during the filtration operation, then metal ions carried from bulk solution to membrane surface where ion exchange reaction takes place. Accordingly, using grafted membrane, influence of liquid flow rate on metal removal performance is minimum, which enables to create the filtering devices with high flow rate with small filter unit. However, the amount of functional groups to be introduced into the micro porous membrane base material by graft polymerization is limited, thus ion exchange capacity which can be achieved by the grafted ion exchange micro porous membrane is also limited. Particularly, the introduction of functional groups into a porous membrane by graft polymerization remarkably reduces the physical/mechanical strength of the base material. It depends on the amount of the introduced functional groups, and thus when a large amount of functional groups are introduced into the porous base membrane clefts and cracks appears on graft membrane during the pleating process in a cartridge assembly. It has been difficult to produce a grafted micro porous membrane having a high ion exchange capacity. Accordingly, the ion exchange capacity of the functional membrane obtained by introducing ion exchange groups into a micro porous membrane by graft polymerization is extremely small and such a functional membrane that comes into practical use has loosing the metal removal performance in a small amount of process volume. In addition, when graft polymerization of a micro porous membrane base material is conducted, there has been observed a problem such as the change in the shape of micro pores. It is caused by penetration of the monomer into the membrane base material or the pores of the porous membrane are clogged with the ion exchange groups introduced by graft polymerization thereby resulting in the change in increase of flow resistance and decrease of flow rate.

In the field of gas filters, filter materials having a function of efficiently removing gaseous molecules are produced by introducing ion exchange groups onto a fiber membrane material such as a woven fabric and a non-woven fabric by graft polymerization. However, in general, the fiber membrane material of the conventional non-woven fabric, which is being used in such applications has much larger pore size than a micro porous membrane. The diffusion rate of metal ions and fine particles in a liquid is slower than that of gaseous acidic or basic impurities. Thus, when the non-woven fabric which is conventionally used in the field of gas filters, is used for the liquid filters, it cannot obtain satisfactory removal performance at the liquid flow rate which liquid filter cartridges typically use. For the above described reason, in the filed of liquid filter cartridges, the fiber membrane material such as a non-woven fabric is at present used as the support material to protect micro porous membrane during the cartridge assembly process.

A trace amount of metal impurities dissolved in ultra pure water or organic solvent are known as dispersed in with various states, and it differs from different metals in different conditions. For example, some metal dissolved in chemical as ionic form, some dispersed as colloidal particles, and some dissolved with forming metal complex. And other impurities in the form of fine particles include, for example, plastic fine particles that are generated from polytetrafluoroethylene used as the structural material such as tubing or bulbs, and fine particles of metal oxides, metal hydroxides contaminated from elsewhere. Metal impurities dissolved in a liquid are some time condensed to form colloidal fine particles. These colloidal fine particles are formed by condensation of metal aqua complexes and neutralize electrical charges on metal ions and form colloidal fine particles having a large mass and a small charge density. Particularly when an impurity of a metal such as iron or aluminum is present in an organic solvent, it is known that these colloidal fine particles are thermodynamically stable than dissolved as ionic form. It is known that appearance and characteristics such as particle size distribution, charge density or the shape of colloidal particles varies depending on the conditions of the solution. For example, the type of the solvent and the metal, pH, temperature and the like, many of colloidal metal impurities have large particle size distribution. Thus, since colloidal particles having a relatively large particle size has a small charge density, metal impurities cannot be completely removed by the ion exchange apparatus utilizing the electrostatic effect in the form of a chemical filter accompanied with liquid flow.

As the purification technology to remove fine particles from various types of liquids, the method of surface filtration and sieving filtration has been used with various types of filter media. Furthermore in recent years, by imparting a high zeta potential to the surface of micro porous filter membrane, filter for removing fine particles and ions with high efficiency has been developed and utilized in various industrial applications. It is important that the filters possess a dual entrapping mechanism, particularly it is necessary in the micro filtration purification of micro-electronics grade chemicals with high purity with high flow rate to be used in the microelectronics device fabrication process. Since it is obvious that by the mechanical entrapping mechanism alone, particles having a smaller particle size than the size of membrane pore cannot be entrapped. Capturing of colloidal particles of iron oxide and aluminum oxide having a particle size of not greater than 0.01 μm which are dispersed in ultrapure water or an organic solvent is insufficient by mechanical filtration alone. Similarly, the charged fine particle entrapping mechanism by electrostatic adsorption alone has been insufficient to entrap and remove coarse particles having a low charge density from a chemical in the micro filtration process with a high flow rate. This is because the inertia force of coarse particles in the fluid flow is greater than the electrostatic force between colloidal particles and charged functional groups. Namely, in the micro filtration of ultra pure solvent or water at a high flow rate to be used in the microelectronics device fabrication process, according to the filter medium having a function of either one of mechanical filtration or electrostatic adsorption mechanism. The purification capability becomes insufficient to achieve the required level of cleanliness in semiconductor industry near future, and thus the development of a new technology has earnestly been desired.

As the surface modification technique for introducing an electrostatic adsorption capacity to micro porous membrane, a method of introducing cationic charges to a filter membrane surface with the use of a cationic charge modifier to increase an attractive force between charged particles and the filter surface was reported. The cation charge modifiers to be used for this purpose include, for example, a polyamide-polyamine epichlorohydrin cationic resin, a melamine-formaldehyde cationic resin and a condensation product of dicyandiamide/monoethanol amine/formaldehyde. The characteristic feature of this technique is to efficiently remove fine particles by chemically modified surface of micro porous membrane with the cationic charge modifier to generate a zeta potential to attract charged particles in the solution. Further, a method of surface modification of micro porous membrane by chemical cross-linking polyamide or polyacrylic acid thereto with the use of a cross-linking agent is also proposed. However, although the micro-filtration membranes produced by these methods possess good impurity removal performance, the efficiency and the capacity have still been insufficient for the microfiltration of chemicals in the micro-electronics device fabrication process which requires that described above.

It is proposed that functional membranes which enable removal of metal impurity are provided by introducing ion exchange groups on to the surface of a micro porous membrane having fine particles removal performance. As the method of introducing ion exchange groups, for example, a radiation induced graft polymerization method can be used. However, as explained above, when a porous membrane is subjected to graft polymerization, the weakening in the mechanical strength of the membrane base material is occurred. Irradiation of electron beam during the graft polymerization reduces the physical/mechanical strength of the base material to form clefts and cracks on grafted micro porous membrane on a pleat. And also, the reduction in the liquid flow rate occurs by swelling of the graft layer by solvent within the pores. Accordingly, the functional membrane obtained by introducing ion exchange groups on to a micro porous membrane by the graft polymerization method has had a problem of the insufficiency of metal impurity removal efficiency or small metal entrapping capacity. Furthermore, there have also been problems of the change in the shape of the pores caused by the penetration of the monomer into the membrane base material or clogging of the pores of the micro porous membrane with the ion exchange groups introduced by the graft polymerization method accompanied with the decline in flow rate.

As explained above, in the existing techniques, chemical purification equipment which simultaneously achieves impurity removal efficiency and capability which meet the requirements in the latest microelectronics device fabrication process in the near future cannot be found at present time. In other words, the development of filter cartridges for purifying chemicals which overcome the defects of the existing purification devices to simultaneously remove impurities of metal and fine particles in a liquid with one step process and immediately before use (at POU, point of use) with good efficiency is earnestly desired.

### DISCLOSURE OF THE INVENTION

The present inventors have found as present invention with vigorous investigations to solve the above described problems that a filter cartridge capable of very efficiently removing metal impurities in water or an organic medium can be obtained by constituting the filter cartridge with the use of a fiber membrane material obtained by introducing ion exchange groups and/or chelate groups into an organic polymer fiber membrane base material having an average fiber diameter of 0.1 μm to 20 μm and an average pore size of 1 μm to 20 μm, and have accomplished the present invention. Namely, the first embodiment of the present invention relates to a filter cartridge which characteristically comprises a fiber membrane material obtained by introducing ion exchange groups and/or chelate groups into an organic polymer fiber membrane base material having an average fiber diameter of 0.1 μm to 20 μm and an average pore size of 1 μm to 20 μm. The fiber membrane base material having such a characteristic feature relating to the first embodiment of the present invention maintains excellent mechanical strength even when the ion exchange groups and/or chelate groups are introduced by grafting method and also has a small fiber diameter and a large surface area, and thus metal impurities in liquid to be filtered efficiently come into contact with the surface of the fiber membrane material by a simple filtration operation and can be removed with high efficiency even when the liquid is allowed to flow at a high flow rate. Thus, according to the filter cartridge of the first embodiment of the present invention, trace amounts of metal impurities can be effectively removed by adsorption/filtration from a chemical to be used in the microelectronics device fabrication steps using existing filtration equipment.

Furthermore, the present inventors have found as another means to solve the above described problems that by combining the fiber membrane material in which ion exchange groups and/chelate groups have been introduced by graft polymerization with a micro porous membrane material having fine particle removal capability to constitute a filter cartridge, all of metal ions, colloidal metal and metal impurities in the form of fine particles present in ultrapure water and chemicals as impurities can be very efficiently removed. Namely, the second embodiment of the present invention relates to a filter cartridge which characteristically comprises a fiber membrane material obtained by introducing ion exchange groups and/or chelate groups into an organic polymer fiber membrane base material, and a micro porous membrane material. It has been found that according to the filter cartridge of the second embodiment of the present invention, the above described impurity removable performance is improved by leaps and bounds beyond the range expected by a person with ordinary skill in the art, compared to the filter cartridge singly using the graft polymerized fiber membrane material or the micro porous material.

### BRIEF EXPLANATION OF THE DRAWINGS

FIG. 1 is a graph showing the experimental results of Example 8.

FIG. 2 is a graph showing the experimental results of Example 15.

### BEST MODE FOR WORKING THE INVENTION

The constitution of the present invention will be explained in detail below.

As stated above, the first embodiment of the present invention relates to a filter cartridge characteristically comprising a fiber membrane material obtained by introducing ion exchange groups and/or chelate groups into an organic polymer fiber membrane base material having an average fiber diameter of 0.1 μm to 20 μm and an average pore size of 1 μm to 20 μm.

In the first embodiment of the present invention, as the fiber base material which can be used as the base material of the filter, fibers of polymeric materials and their weaves, cloth or assemblies such as woven fabrics or non-woven fabrics can suitably be employed. The polymeric fiber base materials include polyolefins such as polyethylene and polypropylene; halogenated polyolefins such as polytetrafluoroethylene (PTFE), polyvinylidene fluoride and polyvinyl chloride; polyesters such as polycarbonate; polyether, polyethersulfone, polysulfone, cellulose and their copolymers; olefin copolymers represented by an ethylene-ethylene tetrafluoride copolymer, an ethylene-vinyl alcohol copolymer (PVAL) and the like. The fiber membrane materials which are made of these materials and have an average fiber diameter of 0.1 μm to 20 μm and an average pore size of 1 μm to 20 μm have a large surface area and are able to have a large ion exchange capacity, and furthermore are light weight and easy to fabricate. The example of the fiber membrane include continuous fibers and their fabricated pieces, discontinuous fibers and their fabricated pieces and their cut single substances. The continuous fibers include, for example, continuous filaments, and the discontinuous fibers include, for example, staple fibers. The fabricated pieces of continuous fibers and discontinuous fibers include various woven fabrics and non-woven fabrics to be produced from these fibers. Further, the woven/non-woven fabric can suitably be used as the base material for radiation graft polymerization which will be described below and, simultaneously, is lightweight and easy to fabricate in the form of a filter, and accordingly is suited for the fiber base material to be used in forming a filter cartridge according to the first embodiment of the present invention.

The fiber base material which can be used in the first embodiment of the present invention is characterized by having an average fiber diameter of 0.1 μm to 20 μm and an average pore size of 1 μm to 20 μm. Furthermore, the average fiber diameter of the fiber base material of the first embodiment of the present invention is preferably 0.2 μm to 15 aim, and more preferably 0.5 μm to 10 μm. Further, the average pore size of the fiber base material of the first embodiment of the present invention is preferably 1 μm to 10 μm and more preferably 1 μm to 5 μm. In the present invention, the average pore size of the fiber base material was determined by the bubble-point method. In the first embodiment of the present invention, by constituting a filter cartridge with the use of a fiber membrane material obtained by introducing ion exchange groups and/or chelate groups into the fiber base material having such a small average fiber diameter and a small average pore size, it has been found that the performance of removing metal impurities in a liquid is improved by leaps and bounds beyond the range of the expectations of a person with ordinary skill in the art. This reason is not clear in detail but as one ground it can be thought that by using a fiber membrane material having a small average fiber diameter and a small average pore size, the surface of the fiber membrane material has been more efficiently able to come into contact with a solution containing metal ions. And also fibrous feature of the membrane material induce a turbulence of the fluid, and increase the rate of ion exchange reaction by increasing the mass transfer rate of metal ion to membrane surface.

In the first embodiment of the present invention, graft polymerization methods can be used as the means to introduce ion exchange groups and/or chelate groups into the fiber base material. Above all, radiation graft polymerization method can suitably be used. The radiation graft polymerization is a method which comprises irradiating an organic polymer base material with radiation to form radicals and allowing a graft monomer to initiate graft polymerization therewith to enable introduction of desired graft polymer side chains covalently on to the main polymer chain. Since the number and the length of graft chains can easily be controlled and the graft polymer side chain can be introduced into various forms of arbitrary polymeric materials, the radiation graft polymerization method is most favorable for the purpose of the present invention. When the radiation graft polymerization method is used, ion exchange groups and/or chelate groups are introduced into the polymer base material in the form of a graft chain having these functional groups.

Radiation that can be used in the radiation graft polymerization method capable of being suitably used for the purpose of the present invention includes, for example, α-rays, α-rays, γ-rays, an electron beam and ultraviolet rays, and γ-rays and an electron beam are favorable for use in the present invention. The radiation graft polymerization method includes a pre-irradiation graft polymerization method comprising exposing base material to radiation as a first step, and then membrane is directly contacted to polymerizable monomer (a graft monomer) to polymerization reaction to occur, and a simultaneous irradiation graft polymerization method comprising irradiating with radiation in the co-presence of a base material and a monomer, and either method can be employed in the present invention. Further, depending on the method of bringing a base material into contact with a monomer, there are a liquid phase graft polymerization method comprising conducting polymerization while the base material is dipped in a monomer solution, a gas phase graft polymerization method comprising bringing a monomer vapor into contact with a base material to initiate polymerization, an impregnated graft polymerization method comprising dipping a base material in a monomer solution, and then taking the base material out of the monomer solution to conduct the reaction with a monomer wet membrane, and the like, and any method can be used in the present invention.

Fibers and a fiber assemblies such as woven/non-woven fabrics are most favorable materials which are used as the organic polymer base materials for producing filter materials according to the first embodiment of the present invention and they hold monomer solution within membrane pores after dipping, and accordingly are suited for use in the impregnated graft polymerization method. Further, when functional groups such as ion exchange groups and/or chelate groups are introduced into a micro porous membrane base material by the radiation graft polymerization method, the significant reduction in the mechanical strength of the base material is occurred, and thus it is impossible to introduce not less than a certain level of functional groups. However, fiber membrane base materials such as woven/non-woven fabrics do not cause the reduction in the mechanical strength even when ion exchange groups and/or chelate groups are introduced thereinto by the radiation graft polymerization method, and thus a much larger amount of functional groups can be introduced compared as the case of using a micro porous membrane base material.

In the first embodiment of the present invention, the ion exchange groups which can be introduced into an organic polymer fiber membrane base material include, for example, a sulfonic acid group, a phosphoric acid group, a carboxyl group, a quaternary ammonium group, and a primary, secondary or tertiary lower amino group. The chelate groups includes, for example, functional groups derived from iminodiacetic acid and its salt, functional groups derived from various amino acids such as glutamic acid, aspartic acid, lysine and proline, a functional group derived from iminodiethanolamine, a dithiocarbamic acid group and a thiourea group.

In order to produce the fiber membrane material which constitutes a filter cartridge according to the first embodiment of the present invention, any of a method comprising graft polymerization with monomer (a graft monomer) having the above described ion exchange group and/or chelate group on the main chain of the fiber base membrane material and a method comprising graft polymerization with graft monomer as such which does not have an ion exchange group and/or a chelate group but has a functional group convertible to one of these groups on the main chain of the fiber base material, and then converting the functional group on the polymer side chain into an ion exchange group and/or a chelate group can be employed. The polymerizable monomers having an ion exchange group which can be used for this purpose include, for example, polymerizable monomers having a sulfonic acid group such as styrenesulfonic acid, vinylsulfonicu acid, their sodium salts and ammonium salts; polymerizable monomers having a carboxyl group such as acrylic acid and methacrylic acid; polymerizable monomers having an amine based ion exchange group such as vinylbenzyltrimethyl-ammonium chloride (VBTAC), dimethylaminoethyl methacrylate (DMAEMA), diethylaminoethyl methacrylate (DEAEMA) and dimethylaminopropylacrylamide (DMAPAA). Further, the polymerizable monomers as such which do not have an ion exchange group and/or a chelate group but have a functional group convertible to an ion exchange group and/or a chelate group include, for example, glycidyl methacrylate, styrene, acrylonitrile, acrolein and chloromethylstyrene. For example, a strongly acidic cation exchange group of a sulfonic acid group can be introduced on to a graft polymer side chain by graft polymerizing styrene on to a fiber base material, and then reacting the resulting product with sulfuric acid or chlorosulfonic acid to effect sulfonation. Further, for example, a chelate group of an iminodiethanol group can be introduced onto a graft polymer side chain by graft polymerizing chloro-methylstyrene on to a fiber base material, and then dipping the base material in an iminodiethanol aqueous solution. Furthermore, for example, a chelate group of an iminodiacetic group can be introduced on to a graft polymer side chain by graft polymerizing a p-haloalkylstyrene on to a fiber base material, substituting halogen group on the formed graft polymer side chain with iodine, then reacting the resulting product with diethyl iminodiacetate to substitute the iodine with the diethyl iminodiacetate group, and further hydrolyzing the ester group with a sodium hydroxide aqueous solution.

The filter cartridge according to the first embodiment of the present invention, as stated above, comprises a fiber membrane material obtained by introducing ion exchange groups and/or chelate groups into an organic polymer fiber membrane base material having an average fiber diameter of 0.1 μm to 20 μm and an average pore size of 1 μm to 20 μm. According to the first embodiment of the present invention, since a high surface concentration of ion exchange groups and/or chelate groups can be introduced into a fiber membrane material, a large volume of metal contaminated solution can be treated compared to the conventional case of effecting grafting on to a micro porous membrane. Accordingly, the present invention provides a filter cartridge having the same shape and dimension as the conventional one but enabling efficient removal of metal ion impurities from, for example, rinse water or a photoresist solution to be used in microelectronics device fabrication steps or the like.

Further, by introducing ion exchange groups and/or chelate groups into a fiber membrane material such as a non-woven fabric which has been used as the support material for a micro porous membrane in the conventional filter cartridge, metal impurities in a chemical and rinse water can be removed by the same operation as in the filtration step at POU which has generally been conducted heretofore without causing a structural load on the body of a microelectronics device fabrication tools. The first embodiment of the present invention can be very easily adapted within an actual apparatus which is used at present in the semiconductor device production without adding any modification to the process which have been conducted heretofore, and thus it can be thought that from that aspect as well, the present invention provides a breakthrough to semiconductor industry to make next step of further advancement. The filter cartridge according to the first embodiment of the present invention can reduce metal impurities in a chemical when placed in circulation line in the chemical delivery system. Further, by placing the filter cartridge of the first embodiment of the present invention in the chemical feed line at POU, the contamination from the transfer path such as tubing and bulbs can be prevented to touch the wafer surface.

Further, the second embodiment of the present invention relates to a filter cartridge characteristically comprising a fiber membrane material obtained by introducing ion exchange groups and/or chelate groups into an organic polymer fiber membrane base material and a porous membrane material.

In the second embodiment of the present invention, as the fiber base material which can be used as the base material, various types of polymeric materials and their assemblies such as woven fabric or non-woven fabric which have been explained in relation to the above described first embodiment of the present invention can suitably be used. Provided that in the second embodiment of the present invention, the average fiber diameter and the average pore size of the fiber base material are not limited.

Further, in relation to the graft polymerization method which can be used as the means to introduce ion exchange groups and/or chelate groups into the fiber base material, the ion exchange groups which can be introduced into the organic polymer fiber membrane base materials, the fiber membrane material production steps and the like, the same explanation relating to the above described first embodiment of the present invention can apply to the second embodiment of the present invention.

It is preferred that the fiber base material which is used in the second embodiment of the present invention has an average fiber diameter of 0.1 μm to 50 μm and an average pore size of 0.1 pn to 100 μm. In a more preferred embodiment of the second embodiment of the present invention, the fiber base material has an average fiber diameter of 0.1 μm to 20 μm and an average pore size of 1 μm to 20 μm. In a still more preferred embodiment, the average fiber diameter of the fiber base material is preferably 0.2 μm to 15 μm and more preferably 0.5 μm to 10 μm. Further, the average pore size of the fiber base material according to the second embodiment is preferably 1.0 μm to 10 μm and more preferably of 1.0 μm to 5 μm. As described above, it has been found that when the filter cartridge is constituted by using a fiber base material having a smaller average fiber diameter and a smaller average pore size, performance of removing various metal impurities is enhanced by leaps and bounds.

The filter cartridge according to the second embodiment of the present invention is characterized by combined use of the above described functional group-introduced fiber membrane material and a micro porous membrane material. The micro porous membrane materials which can be used in the second embodiment of the present invention include porous polymer membranes and existing porous molecular membranes including inorganic substances. The materials of the membranes include, for example, polyolefins such as polyethylene and polypropylene; halogenated polyolefins such as PTFE, polyvinylidene fluoride and polyvinyl chloride; polyesters such as polycarbonate; polyether, polyethersulfone, polysulfone, cellulose, and their copolymers; and olefin copolymers represented by an ethylene-ethylene tetrafluoride copolymer, an ethylene-vinyl alcohol copolymer (EVAL) and the like.

It is preferred that the porous membrane material to be used in the second embodiment of the present invention has an average pore size of 0.02 μm to several microns and more preferably of 0.02 μm to 0.5 μm. Further, in the present invention, the average pore size of a micro porous membrane was determined by the same method as the method for determining the average pore size of the fiber membrane material as explained above.

The filter cartridge according to the second embodiment of the present invention is characteristically constituted by bi-layer structure of the above described functional group-introduced fiber membrane material and a micro porous membrane material. By laminating these materials having excellent mechanical strength to form a pleated sheet and to assemble a filter cartridge, it makes possible to hold a large membrane area within the filter cartridge. Thus, within the range of actual process flow rate, the performance of removing metal impurities has been effected even at high flow rate.

Particularly, in the second embodiment of the present invention, by laminating the functional group-introduced fiber membrane material with the micro porous membrane material to assemble a filter cartridge, even for a liquid containing colloidal particles having high mass/low charge density formed by the aggregation of iron and aluminum ion in an organic solvent, the colloid particles and metal impurities of fine particles in other forms and metal ion impurities can be removed by using the method of this invention. The mechanism is unclear but it can be thought that combined use of the porous membrane and the grafted fiber membrane material undertakes the former to the role of mechanical filtration, that 1 is, removal of colloidal particles having a larger particle diameter than the pore size of the membrane and the latter to the role of electrostatic adsorption, that is, the removal of colloidal fine particles having a small particle diameter and a small mass with a high charge density, and simultaneously adsorb ionic metals. The roles of the porous membrane and the grafted fiber membrane material are suitably allotted to surprisingly enhance the performance of removing fine particles over a wide range of small particle diameters to large particle diameters, compared to single use of each filter cartridge.

According to the second embodiment of the present invention, by laminating a fiber membrane material in which ion exchange groups and/or chelate groups have been introduced with a micro porous membrane material to assemble a high performance filter cartridge, a large number of ion exchange groups and/or chelate groups are introduced within the filter cartridge, and thus metal ion removal performance having extremely long filter life time can be obtained. Also, the final form of the inventions contain the same size and shape as the conventionally employed filter cartridge. Purification by removing of not only particles but also metal ions and, colloidal fine particles from the rinse water and a chemical such as a photoresist to be used in the microelectronics device fabrication process has been enabled. Further, the introduction of ion exchange groups and chelate groups into a fiber membrane material such as a non-woven fabric which has conventionally been used as the support material for a micro porous membrane in a liquid filter cartridge has enabled simultaneous removal of particles and metal impurities by the same operation as in the filtration process at POU which has been conventionally conducted without adding any modification to process or tools. From these aspects as well, benefits to the present invention to the semiconductor industry can be thought to be significant. By placing the filter cartridge according to the second embodiment of the present invention at circulating line of the chemical delivery system of the micro-electronics device fabrication process, the metal impurities in the chemical can be reduced. Further, by placing the filter cartridge according to the second embodiment of the present invention to POU in the chemical feed line. The contamination from the transfer path such as tubing and bulbs can be effectively removed before the wafer get expose to chemicals in addition to the removal of metal impurities originally present in a chemical.

Furthermore, the form of invention include introduction of a functional groups such as ionic hydrophilic groups and nonionic hydrophilic groups onto the micro porous membrane material. In this case, the introduction of an excessively large amount of functional groups into the micro porous material by a graft polymerization method is disadvantageous to cause problems such as failure in physical/mechanical strength of the porous membrane material as stated above. However, it is advantageous to introduce functional groups as hydrophilic groups in an appropriate amount which does not cause these problems into the micro porous membrane by a graft polymerization method or the like. It is well investigated that the surface energy difference between micro porous membrane and liquid changes the de-wetting behavior of the membrane and for high surface tension liquid it improves the start up property by measured by the shedding of micro bubbles from the filter when hydrophilic groups are introduced. Further, since fine particles such as metal oxide and metal hydroxides in a liquid are usually positively charged, it can be expected that when ionic hydrophilic groups having a negative charge are introduced into the porous membrane material, these fine particles in the liquid can be electrostatically adsorbed on the ionic hydrophilic groups on the porous membrane and removed.

The functional groups which can be introduced into the micro porous membrane for this purpose is including ionic hydrophilic groups such as a sulfonic acid group, a phosphoric acid group, a carboxyl group, a quaternary ammonium group, and a primary, secondary or tertiary lower amino group; and nonionic groups such as an amide group and a hydroxyl group. As the technique of introducing a polymer side chain containing these hydrophilic groups, a method comprising graft polymerization with monomer (graft monomer) having a hydrophilic group and a method comprising graft polymerization with monomer with which does not have a hydrophilic group but can convert to a hydrophilic group, can be employed. The polymerizable monomers having an ionic hydrophilic group include, for example, polymerizable monomers having a sulfonic acid group such as styrenesulfonic acid, vinylsulfonic acid, their sodium salts and ammonium salts; polymerizable monomers having a carboxylic acid group such as acrylic acid and methacrylic acid; and polymerizable monomers having an amine based ionic hydrophilic group such as vinylbenzyltrimethylammonium chloride (VBTAC), dimethylaminoethyl methacrylate (DMAEMA), diethylaminoethyl methacrylate (DEAEMA) and dimethylaminopropylacrylamide (DMAPAA). The polymerizable monomers having a nonionic hydrophilic group of an amide group include, for example, acrylamide, dimethylacrylamide, methacrylamide, and isopropylacrylamide. The polymerizable monomers having a nonionic hydrophilic group of a hydroxyl group include 2-hydroxyethylmethacrylate. The polymerizable monomers as such which do not have one of these hydrophilic groups but can convert to hydrophilic groups include, for example, glycidyl methacrylate, chloromethylstyrene and vinyl acetate. As the method of graft polymerizing these polymerizable monomers and then introducing hydrophilic groups into the grafted polymer, known methods can be employed. For example, hydroxyl groups can be introduced on to the polymer side chain by graft polymerization of vinyl acetate, and then alkali hydrolysis reaction with a sodium hydroxide/methanol mixture gives hydroxyl group. As the means to introduce these functional groups into a porous membrane material, the above stated graft polymerization method, particularly the radiation graft polymerization method can be preferably used.

Further, in introducing functional groups into a micro porous membrane material by the graft polymerization method in the second embodiment of the present invention, the degree of grafting of between 5% to 50% is preferred in consideration of to prevent above stated various problems to occur.

### INDUSTRIAL APPLICABILITY

According to the filter cartridge of first embodiment of the present invention, by introducing a large amount of functional groups into a fiber membrane material, trace amounts of metal impurities in a chemical that has been used in the microelectronics device fabrication process can be very efficiently removed. The filter cartridge according to the second embodiment of the present invention, by arranging bi layered structure with grafted ion exchange and/or chelate fiber membrane and micro porous membrane, the metal removal performance was enhanced with removing fine charged articles, metal ions, colloidal metal and the like by leaps and bounds which could not be achieved by a micro porous membrane filter alone. The filter cartridge according to present invention, have the same size and shape as the conventional cartridge and be able to remove metal impurity while maintaining the fine particle removal performance which the conventional micro porous membrane filter possesses.

The present invention will be more specifically explained by the following examples which illustrate embodiments of the present invention and the present invention is not to be limited by the descriptions of these examples.

### EXAMPLE 1

Preparation of Styrene Sulfonic Acid Grafted Cation Exchange Filter Cartridge 1

Under nitrogen atmosphere, 83 g of a non-woven fabric made from high density polyethylene (HDPE) [a product of E. I. du Pont de Nemours & Co., Inc., trade name “Tyvek”: average fiber diameter=0.5 to 10 μm, average pore size (measured by the bubble-point method)=5 μm, density=65 g/m², thickness=0.17 mm] was irradiated with an electron beam with 150 kGy. This irradiated non-woven fabric was dipped in 30% styrene/toluene solution, and then placed in a glass vessel and the followed by polymerization for three hours at 50° C. in vacuo. The resulting grafted non-woven fabric was washed with toluene at 60° C. for three hours to remove undesired homopolymer. The obtained non-woven fabric was further washed with acetone and then dried at 50° C. for 12 hours to obtain 136 g of a styrene grafted non-woven fabric. The degree of grafting was 64%.

The obtained styrene grafted non-woven fabric was soaked in a chlorosulfonic acid/dichloromethane (weight ratio 2:98) mixture to conduct sulfonation reaction at 0° C. for one hour. The resulting non-woven fabric was taken out, washed in the order with methanol/dichloromethane mixture (weight ratio: 1:9), methanol and water and dried to obtain a styrene sulfonic acid grafted non-woven fabric with a thickness of 0.27 mm and an ion exchange capacity of 328 meq/m².

Using the styrene sulfonic acid grafted non-woven fabric prepared above (effective width: 220 mm), a pleated non-woven fabric having a pleat height of 11.5 mm and a number of pleats of 120 was prepared. The effective membrane area of this pleated non-woven fabric was 0.61 m². This pleated non-woven fabric was heat seamed the each end then wrapped around an HDPE inner core (diameter: 46 mm, length: 220 mm) which was then inserted into a filter cage (inner diameter: 76 mm, height: 220 mm). The filter cage was sealed with bottom and top caps by heat potting method to form a high performance filter cartridge 1 having a total ion exchange capacity per cartridge of 200 meq.

### EXAMPLE 2

Preparation of Glycidyl Methacrylate Sulfonic Acid Grafted Cation Exchange Filter Cartridge 2

Under the conditions described in Example 1, 83 g of the non-woven fabric used in Example 1 was irradiated with an electron beam, and then dipped in glycidyl methacrylate. The sample was placed in a glass vessel, and then graft polymerization was conducted at 50° C. for three hours in vacuo. The resulting grafted non-woven fabric was taken out and soaked in dimethylformamide at 60° C. for three hours to remove undesired homopolymer. The obtained non-woven fabric was further washed with acetone and then dried at 50° C. for 12 hours to obtain 164 g of a glycidyl methacrylate grafted non-woven fabric. The degree of grafting was 97%.

The grafted non-woven fabric obtained above was soaked in a sodium sulfite in isopropanol/water mixture (sodium sulfite 80 g/sodium hydrogen sulfite 40 g/isopropanol 120 g/water 760 g), and sulfonation reaction was carried out at 90° C. for six hours. The resulting non-woven fabric was taken but, washed in the order with pure water, 2N-hydrochloric acid and pure water and dried to obtain a sulfonic acid grafted cation exchange non-woven fabric with a thickness of 0.29 mm and an ion exchange capacity of 294 meq/m².

From grafted cation exchange non-woven fabric prepared above (effective width: 220 mm), a pleated non-woven fabric with a pleat height of 11.5 mm and a number of pleats of 110 was prepared. The effective area of this pleated non-woven fabric was 0.56 m². Using this pleated non-woven fabric, a high performance filter cartridge 2 having a total ion exchange capacity per cartridge of 165 meq was assembled with the use of the same filter core and filter cage as in Example 1.

### EXAMPLE 3

Preparation of Iminodiethanol Grafted Chelate Filter Cartridge 3

Under the condition described in Example 1, 83 g of the non-woven fabric as in Example 1 was irradiated with an electron beam, and then dipped in chloromethylstyrene (produced by Seimi Chemical Co., Ltd., trade name “CMS-14”). The non-woven fabric was placed in a glass vessel, and polymerization reaction was conducted at 50° C. for three hours in vacuo. The resulting grafted non-woven fabric was taken out and soaked in toluene at 60° C. for three hours to remove undesired homopolymer. The obtained non-woven fabric was further washed with acetone and then dried at 50° C. under reduced pressure for 12 hours to obtain 154 g of a chloromethylstyrene grafted non-woven fabric. The degree of grafting was 85%.

The non-woven fabric prepared above was soaked in an iminodiethanol/isopropanol (weight ratio 4:6) mixture for 12 hours at 70° C. The resulting non-woven fabric was taken out, washed with methanol and pure water and dried to obtain an iminodiethanol grafted non-woven fabric with a thickness of 0.28 mm and a surface concentration of the introduced iminodiethanol groups was 285 meq/m².

From iminodiethanol grafted non-woven fabric prepared above (effective width: 220 mm), a pleated non-woven fabric having a pleat height of 11.5 mm and a number of pleats of 120 was prepared. The effective area of this pleated non-woven fabric was 0.61 m². Using this pleated non-woven fabric, a high performance filter cartridge 3 having a total amount of functional group introduced per cartridge of 174 meq was assembled with the use of the same filter core and filter cage as in Example 1.

### EXAMPLE 4

Preparation of Iminodiacetic Acid Grafted Chelate Filter Cartridge 4

The chloromethylstyrene grafted non-woven fabric as prepared in Example 3 was soaked in a sodium iodide solution in acetone (weight ratio 1:15) for 24 hours at 50° C. The obtained non-woven fabric was washed with pure water and acetone. Then, iminodiacetic acid groups were introduced as following. The non-woven fabric was soaked in a diethyl iminodiacetate/dimethylformamide mixture (weight ratio 1:9) for 12 hours at 80° C., and the non-woven fabric was transferred to 1N-sodium hydroxide aqueous solution/ethanol mixture (volume ratio 1:1), and then further heated to 70° C. for three hours to hydrolyze ester groups. The obtained non-woven fabric was taken out, repeatedly washed with water and then dried to obtain an iminodiacetic acid grafted non-woven fabric with a thickness of 0.30 mm and an amount of the introduced iminodiacetic acid groups was 306 meq/m².

From the above obtained iminodiacetic acid grafted non-woven fabric (effective width: 220 mm), a pleated non-woven fabric with pleat height of 11.5 and a number of pleats of 110 was prepared. The effective area of this pleated non-woven fabric was 0.56 m². Using this pleated non-woven fabric, a high performance filter cartridge 4 having a total amount of functional groups per cartridge of 171 meq was assembled with the use of the same filter core and filter cage as in Example 1.

### COMPARATIVE EXAMPLE 1

Under the same conditions as in Example 1, 100 g of HDPE non-woven fabric [a product of Japan Vilene Co., Ltd.: trade name=“OX8901”, average fiber diameter=20 to 30 μm, average pore size (determined by the bubble-point method)=120 μm, density=66 g/m², thickness: 0.32 mm] was irradiated with an electron beam. This irradiated non-woven fabric was dipped in styrene and placed in a glass vessel, and then graft polymerization was carried out at 50° C. for three hours in vacuo. The resulting grafted non-woven fabric was washed and dried in the same manner as in Example 1 to obtain 202 g of a styrene grafted non-woven fabric. The degree of grafting was 102%. The obtained styrene grafted non-woven fabric was subjected to sulfonation reaction in the same manner as in Example 1 to obtain a sulfonic acid grafted non-woven fabric having a thickness of 0.9 mm and an ion exchange capacity of 635 meq/m².

When a filter cartridge was assembled by this non-woven fabric (effective width: 220 mm) with the use of the same filter core and filter cage as in Example 1, the non-woven fabric came to a pleated non-woven fabric with pleat height of 11.5 mm and a number of pleats of 80 due to its large thickness, and the ion exchange capacity per cartridge obtained was 257 meq.

### COMPARATIVE EXAMPLE 2

Under the same conditions as in Example 1, 39 g of a micro porous membrane made of ultra high molecular weight polyethylene (porosity: 0.7, thickness: 0.05 mm, average pore size of 0.5 μm) was irradiated with an electron beam. A well degassed glycidyl methacrylate/dimethylformamide (weight ratio 1:1) mixture was placed in a glass vessel and the above irradiated porous membrane was dipped therein, and the atmosphere in the vessel was replaced with nitrogen, and then graft polymerization was carried out for one hour at 40° C. The resulting grafted porous membrane was washed and dried in the same manner as in Example 2 to obtain 51 g of a glycidyl methacrylate grafted micro porous membrane. The degree of grafting was 32%. The obtained micro grafted porous membrane was sulfonated in the same manner as in Example 2 to obtain a sulfonic acid grafted ion exchange micro porous membrane B having a thickness of 0.1 mm and an ion exchange capacity of 57 meq/m².

### COMPARATIVE EXAMPLE 3

The same micro porous membrane made of ultra high molecular weight polyethylene as in Comparative Example 2 was irradiated with an electron beam under the same conditions as in Example 1. A well degassed glycidyl methacrylate/dimethylformamide (weight ratio 4:1) mixture was placed in a glass vessel and the above irradiated micro porous membrane was dipped therein, and the atmosphere in the vessel was replaced with nitrogen, and then graft polymerization was carried out for four hours at 50° C. The resulting grafted micro porous membrane was washed and dried in the same manner as in Example 2 to obtain 76 g of a glycidyl methacrylate grafted micro porous membrane. The degree of grafting was 94%. To the obtained grafted membrane, sulfonic acid groups were introduced by the same manner as in Example 2 to obtain a sulfonic acid grafted ion exchange micro porous membrane C having a thickness of 0.17 mm and an ion exchange capacity of 171 meq/m². This ion exchange micro porous membrane was brittle and when it was fabricated into pleats, fine cleft and crack were appeared at folds. The ion exchange membrane C could not withstand practical use as the pleated filter.

### EXAMPLE 5

### Metal Challenge Test

A metal challenge test was conducted by using the sulfonic acid grafted non-woven filter cartridge 1 as prepared in Example 1. As the feed solution, ultra pure water containing 200 ppb of iron was allowed to flow at a flow rate of 5.0 L/min to 20 L/min, and concentration of iron in the filtrate was measured by atomic adsorption analysis. The iron concentration in the filtrate was reduced to the range of 0.6 ppb to 1.9 ppb within this range of the liquid flow rate to exhibit good iron impurity removal performance.

### EXAMPLE 6

### Metal Challenge Test

A metal challenge test was conducted by using isopropanol instead of pure water as the feed solution. With the use of an isopropanol solution containing 200 ppb of copper, the experiment was conducted under the same conditions as in Example 5. The copper concentration in the filtrate was reduced to the range of 15 ppb to 21 ppb to exhibit a capability of removing a metal impurity even in the isopropanol medium as in pure water.

### EXAMPLE 7

### Metal Challenge Test

The sulfonic acid type non-woven fabric as prepared in Example 1 was cut into a disk having a diameter of 47 mm (effective area: 13.1 cm²) and fixed in a holder capsule. In this state, a copper (II) nitrate aqueous solution containing 200 ppb of copper was allowed to flow at a flow rate of 10 mL/min to 40 mL/min, and concentration of copper in the effluent was measured. The copper concentration was reduced to the range of 0.3 ppb to 1.5 ppb to exhibit copper impurity removal capability.

The sulfonic acid grafted non-woven fabric A as prepared in Comparative Example 1 was cut into a disk in the same manner as state above and a metal challenge test was conducted under the same conditions as described above. The concentration of copper in the filtrate was reduced only to the range of 45 ppb to 85 ppb.

From the results obtained above, it can be understood that the filter material as prepared by using a non-woven fabric having a fine fiber diameter and a fine pore size according to the present invention has extremely higher capability and performance of removing metal impurities. The difference is significant compared to the filter material as prepared by using the conventional non-woven fabric having a large fiber diameter and a large pore size such as non-woven fabric A.

### EXAMPLE 8

### Filter Life Time Evaluation

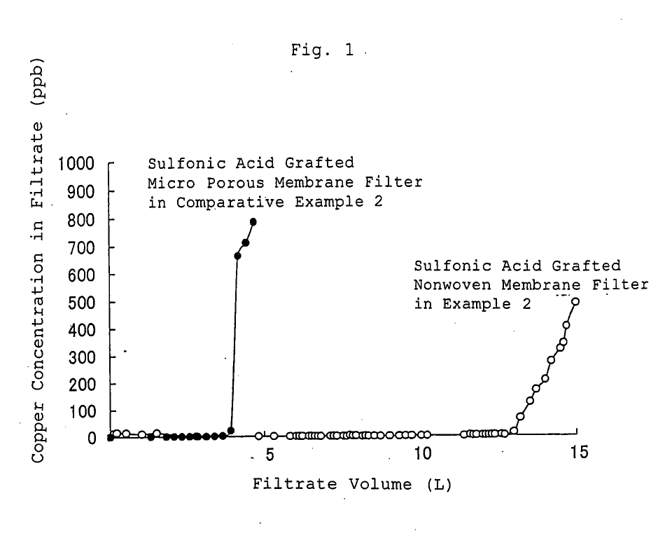

The sulfonic acid grafted non-woven fabric as prepared in Example 2 was cut into a disk with a diameter of 47 mm (effective area: 13.1 cm²) which was then fixed in a holder capsule. A copper (II) nitrate aqueous solution containing 955 ppb of copper was allowed to flow at a flow rate of 5 mL/min. The copper concentration in the filtrate was measured and found to be 0.25 ppb. The copper (II) nitrate aqueous solution was further kept to continuously flow, until the metal ion breakthrough occurred. At filtrate volume of 13.4 L (see FIG. 1) copper ion started leach out in the filtrate. The total amount of the copper ion adsorbed on the non-woven fabric up to this point was 0.202 mmol. The sulfonic acid grafted non-woven fabric according to the present invention was shown to have a very high ion exchange capacity.

In comparison, the sulfonic acid grafted micro porous membrane B as prepared in Comparative Example 2 was cut into a disk with a diameter of 47 mm (effective area: 13.1 cm²), and when a metal challenge test was conducted under the same conditions as described above. The copper ion concentration in the initial filtrate was as low as 0.1 ppb but when the copper (II) nitrate aqueous solution was further kept to continuously flow, the metal breakthrough occurred at a filtrate volume of 4.5 L (see FIG. 1). The total amount of the copper ion adsorbed on the micro porous membrane up to this point was 0.0687 mmol.

From the above results, it has been recognized that the filter material comprising the fiber membrane material according to the present invention retains the capability of removing an extremely large volume of metal impurities and enables prolongation of the filter life.

### EXAMPLE 9

Preparation of Filter Cartridge of Sulfonic Acid Grafted Non-Woven Fabric/Non-Graft Micro Porous Membrane

A bi-layered laminate membrane with a pleat height of 14 mm and a number of pleats of 145 was prepared with the use of two filter membranes, the first one is the sulfonic acid grafted non-woven fabric (effective width: 220 mm) as prepared in Example 1 and the other is a micro porous membrane (effective width: 220 mm) composed of ultra high molecular weight polyethylene (molecular weight: 1,000,000) and having a thickness of 100 μm, a pore size of 0.2 μm and a porosity of 60.0%). The effective area of this pleated laminate filter was 0.89 m². This pleated laminate filter was seamed together and was wrapped around a filter core (diameter: 46 mm, length: 220 mm) made of high density polyethylene. With such a manner that the non-woven fabric came to the outer side and the porous membrane came to the inner side, and inserted into a filter cage (inner diameter: 76 mm, height: 220 mm), and the cage was sealed with the use of top and bottom caps by the heat potting method to assemble a high performance filter cartridge 5.

### EXAMPLE 10

Preparation of Filter Cartridge of Sulfonic Acid Grafted Non-Woven Fabric/Carboxylic Acid Grafted Micro Porous Membrane

Under the same conditions as in Example 9, 39 g of the same micro porous membrane made of ultra-high-molecular-weight polyethylene as used in Example 9 was irradiated with an electron beam. This irradiated porous membrane was dipped in an acrylic acid/water/methanol (weight ratio 10:45:45) mixture, and then polymerization was conducted at 50° C. for two hours in vacuo. The resulting grafted porous membrane was taken out and washed with pure water three times to remove unwanted homopolymer, and further dried at 50° C. for 12 hours to obtain 44 g of an acrylic acid grafted micro porous membrane. The degree of grafting was 12% and the thickness was 0.11 mm.

A pleated laminate filter (effective area: 0.89 m²) with a pleat height of 14 mm and a number of pleats of 145 was prepared with the use of two filter membranes of the sulfonic acid grafted non-woven fabric (effective width: 220 mm) as prepared in Example 1 and the above obtained acrylic acid grafted porous membrane (effective width: 220 mm). In the same manner as in Example 9 the pleated laminated filter was prepared, and then a high performance filter cartridge 6 was assembled with the use of the same filter core and filter cage as in Example 9.

### EXAMPLE 11

Preparation of Filter Cartridge of Sulfonic Acid Grafted Non-Woven Fabric/Carboxylic Acid Grafted Micro Porous Membrane

Under the same conditions as in Example 9, 100 g of an HDPE non-woven fabric composed of polyethylene fibers [a product of Japan Vilene Co., Ltd., trade name “OX8901”: average fiber diameter=20 to 30 μm, average pore size=120 μm (determined by the bubble-point method), areal density=66 g/m², thickness=0.32 mm] was irradiated with an electron beam. This irradiated non-woven fabric was dipped in styrene and placed in a glass vessel, and then polymerization was carried out for three hours at 50° C. in vacuo. The grafted non-woven fabric was washed and dried in the same manner as in Example 9 to obtain 202 g of a styrene grafted non-woven fabric. The degree of grafting was 102%. The obtained styrene grafted non-woven fabric was sulfonated, washed and dried in the manner as in Example 9 to obtain a sulfonic acid grafted non-woven fabric having a thickness of 0.9 mm and an ion exchange capacity of 635 meq/m².

The above obtained sulfonic acid grafted non-woven fabric was arranged bi-layer structure on the acrylic acid graft porous membrane as prepared in Example 10 to prepare a pleated laminate sheet (effective area: 0.55 m²) having a pleat height of 14 mm and a number of pleats of 90. With the use of this pleated laminate sheet, a high performance filter cartridge 7 was assembled in the same manner as in Example 9.

### EXAMPLE 12

Preparation of Filter Cartridge of Sulfonic Acid Grafted Non-Woven Fabric/Quaternary Ammonium Grafted Porous Membrane

Under the same conditions as in Example 9, 39 g of the same micro porous membrane made of ultra-high-molecular-weight polyethylene as used in Example 9 was irradiated with an electron beam. The irradiated micro porous membrane was dipped in a chloromethylstyrene/toluene (weight ratio 1:10) mixture, placed in a glass vessel and graft polymerization was carried out at 60° C. for four hours. The resulting grafted membrane was taken out and washed with toluene and acetone in this order to remove unwanted homopolymer, and further dried at 50° C. for 12 hours to obtain 52 g of a chloromethylstyrene grafted membrane with a degree of grafting of 34%.

19.9 g of the above obtained grafted micro porous membrane was soaked in a trimethylamine/isopropanol/pure water (weight ratio 1:3:10) mixture was kept to effect reaction at 50° C. for 12 hours. The resulting amine modified membrane was taken out, washed with pure water, 0.1N-hydrochloric acid and pure water in this order and further dried at 50° C. for 12 hours to obtain 23.2 g of a quaternary ammonium grafted micro porous membrane. The thickness was 0.13 mm.

A pleated laminate filter with a pleat height of 14 mm and a number of pleats of 145 (effective area: 0.89 m²) was prepared in the same manner as in Example 9 with the use of two filter membranes of the sulfonic acid grafted non-woven fabric (effective width: 220 mm) as prepared in Example 1 and the above obtained quaternary ammonium grafted micro porous membrane (effective width: 220 mm) in a bi-layer structure. A high performance cartridge 8 was assembled by using this pleated laminate filter membrane in the same manner as in Example 9.

### EXAMPLE 13

### Metal Challenge Test

Using the high performance filter cartridges 5, 6 and 7 as prepared in Examples 9 to 11, respectively, metal challenge tests were conducted. Pure water as a feed solution containing 200 ppb of iron was allowed to flow at a flow rate of 5.0 L/min to 20 L/min, and the iron concentration in the filtrate was measured. The iron concentration in the filtrate within the range of this liquid flow rate was decreased to the range of 0.6 ppb to 1.9 ppb with the filter cartridge 5; to the range of 0.02 ppb to 0.04 ppb with the filter cartridge 6; and to the range of 0.9 ppb to 2.2 ppb with the filter cartridge 7. All three of the filter cartridges exhibited excellent iron impurity removal performance. It may be thought that the best result obtained particularly by the filter cartridge 6 was because the use of a carboxylic acid groups-introduced porous membrane as the porous membrane constituting the filter cartridge improves dewetting property of the surface of the micro porous membrane against the water to contribute to the higher removal performances.

### EXAMPLE 14

### Metal Challenge Test: Isopropanol

Metal Challenge tests were conducted with respect to the filter cartridges 5 and 6 in the same manner as in Example 13 except that isopropanol containing 200 ppb of iron was used as the feed solution. Iron concentration in the filtrate was reduced to the range of 0.2 ppb to 0.6 ppb with the filter cartridge 5, and to the range of 0.04 ppb to 0.08 ppb with the filter cartridge 6. Thus, both filter cartridges exhibited good iron impurity removal performances with respect to isopropanol as well as pure water. It may be thought that the extremely good result obtained particularly by the filter cartridge 6 was because the use of a cation exchange group-introduced porous membrane as the porous membrane constituting the filter cartridge improves performance of adsorbing fine charged particles present in the liquid to contribute to the high removal performance.

### COMPARATIVE EXAMPLE 4

Removal of Iron from Isopropanol Using Micro Porous Membrane Filter Cartridge

With the use of the ultra-high-molecular-weight polyethylene micro porous membrane as used in Example 9 and the polyethylene fiber non-woven fabric before graft treatment as used in Example 1 (a product of E. I. du Pont de Nemours & Co., Inc., trade name “Tyvek”)), a pleated laminate sheet was formed in the same manner as in Example 9 and a filter cartridge D was assembled in the same manner as in Example 9. When an isopropanol metal challenge test was conducted under the same conditions as in Example 14 with the use of this filter cartridge D, the iron concentration in the effluent was in the range of 4.0 ppb to 13.1 ppb.

### EXAMPLE 15

### Start Up Property Evaluation in Micro Bubble Shedding

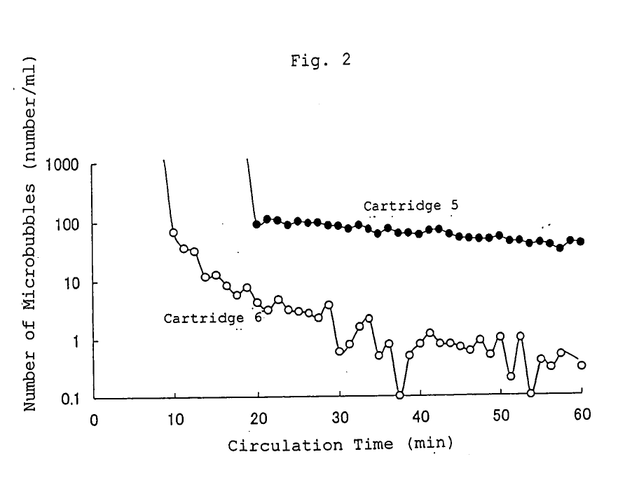

Start up property of high performance filters were evaluated by observing micro bubbles shedding behavior using the high performance filter cartridge 5 as prepared in the above described Example 9 and the high performance filter cartridge 6 as prepared in the above described Example 10, respectively. A circulating vessel filled with 42 L of buffered hydrofluoric acid was connected to a pump, the filter cartridge 5 or 6 and a dynamic light scattering type particle counter in this order in series, and the liquid was circulated at a flow rate of 16 L/min. After starting circulation, the number of microbubbles in the filtrate from the filter cartridge was measured by the particle counter. The results are shown in FIG. 2. In the experiment using the filter cartridge 5 of the sulfonic acid grafted non-woven fabric/non-grafted micro porous membrane, the micro bubbles shedding behavior was observed. On the other hand, in the experiment using the filter cartridge 6 of the sulfonic acid grafted non-woven fabric/carboxylic acid grafted micro porous membrane, the number of micro bubbles were quickly reduced in a short period of time after started the circulation. Faster reduction in number of micro bubbles in the filtrate during the start up demonstrated with filter cartridge 6 was contributed with the surface modification by introducing carboxylic acid groups on the micro porous membrane. The micro porous membrane surface was converted to hydrophilic that changes the surface energy of the membrane and resulted better non-dewetting property against BHF solution.

### EXAMPLE 16

### Metal Challenge Test

A metal challenge test was conducted with the use of the high performance filter cartridge 7 as prepared in the above described Example 11. As the test liquid, pure water having a pH 4 and containing 2.2 ppb of iron was allowed to flow at a flow rate of 5.0 L/min to 20 L/min, and the iron concentration in the filtrate was measured. The iron concentration in the filtrate within this range of the liquid flow rate was reduced to the range of 0.04 ppb to 0.06 ppb to exhibit good iron removal performance. In the same manner, pure water having a pH 7 and containing 4.6 ppb of an aluminum ion was allowed to flow at a flow rate of 5.0 L/min to 20 L/min, and the aluminum concentration in the filtrate was measured. The aluminum concentration in the filtrate was reduced to the range of 0.03 ppb to 0.05 ppb within this range of the liquid flow rate to exhibit good aluminum removal performance.

1-14. (canceled)

15. A filter cartridge comprising a fiber membrane material obtained by introducing ion exchange groups and/or chelate groups into an organic polymer fiber membrane base material having an average fiber diameter of 0.1 μm to 20 μm and an average pore size of 1 μm to 20 μm.

16. The filter cartridge of claim 15, wherein a polymer side chain having ion exchange groups and/or chelate groups is introduced on the main chain of the organic polymer fiber membrane base material by a radiation graft polymerization method.

17. The filter cartridge of claim 15, wherein the fiber base material is a woven fabric or a non-woven fabric.

18. The filter cartridge of claim 15, wherein the ion exchange group is selected from a sulfonic acid group, a phosphoric acid group, a carboxyl group, a quaternary ammonium group, and a primary, secondary or tertiary lower amino group, and the chelate group is selected from an iminodiethanol group, an iminodiacetic acid group, a dithiocarbamic acid group and a thiourea group.

19. A filter cartridge comprising a fiber membrane material obtained by introducing ion exchange groups and/or chelate groups into an organic polymer fiber membrane base material, and a micro porous membrane material.

20. A filter cartridge comprising a fiber membrane material obtained by introducing ion exchange groups and/or chelate groups into an organic polymer fiber membrane base material, and a micro porous membrane material obtained by introducing hydrophilic groups into an organic porous membrane base material.

21. The filter cartridge of claim 19, wherein a polymer side chain having ion exchange groups and/or chelate groups is introduced on the main chain of the organic polymer fiber membrane base material by the radiation graft polymerization method.

22. The filter cartridge of claim 19, wherein the fiber base material is a woven fabric or a non-woven fabric.

23. The filter cartridge of claim 19, wherein the organic polymer fiber membrane base material has an average fiber diameter of 0.1 μm to 50 μm and an average pore size of 0.1 μM to 100 μm.

24. The filter cartridge of claim 23, wherein the organic polymer fiber membrane base material has an average fiber diameter of 0.1 μm to 20 μm and an average pore size of 1 μm to 20 μm.

25. The filter cartridge of claim 19, wherein the ion exchange group is a cation exchange group selected from a sulfonic acid group, a phosphoric acid group and a carboxyl group or an anion exchange group selected from a quaternary ammonium group and a primary, secondary or tertiary lower amino group, and the chelate group is selected from an iminodiethanol group, an iminodiacetic acid group, a dithiocarbamic acid group and a thiourea group, and the hydrophilic group is an ionic hydrophilic group selected from a sulfonic acid group, a phosphoric acid group, a carboxyl group, a quaternary ammonium group, a tertiary amino group, a secondary amino group and a primary amino group or a nonionic hydrophilic group selected from an amide group and a hydroxyl group.

26. The filter cartridge of claim 19, wherein the average pore size of the micro porous membrane is 0.02 μm to 1.0 μm.

27. The filter cartridge of claim 26, wherein the average pore size of the micro porous membrane is 0.02 μm to 0.5 μm.

28. The filter cartridge of claim 20, wherein a polymer side chain having ion exchange groups and/or chelate groups is introduced on the main chain of the organic polymer fiber membrane base material by the radiation graft polymerization method.

29. The filter cartridge of claim 20, wherein the fiber base material is a woven fabric or a non-woven fabric.

30. The filter cartridge of claim 20, wherein the organic polymer fiber membrane base material has an average fiber diameter of 0.1 μm to 50 μm and an average pore size of 0.1 μm to 100 μm.

31. The filter cartridge of claim 30, wherein the organic polymer fiber membrane base material has an average fiber diameter of 0.1 μm to 20 μm and an average pore size of 1 μm to 20 μm.

32. The filter cartridge of claim 20, wherein the ion exchange group is a cation exchange group selected from a sulfonic acid group, a phosphoric acid group and a carboxyl group or an anion exchange group selected from a quaternary ammonium group and a primary, secondary or tertiary lower amino group, and the chelate group is selected from an iminodiethanol group, an iminodiacetic acid group, a dithiocarbamic acid group and a thiourea group, and the hydrophilic group is an ionic hydrophilic group selected from a sulfonic acid group, a phosphoric acid group, a carboxyl group, a quaternary ammonium group, a tertiary amino group, a secondary amino group and a primary amino group or a nonionic hydrophilic group selected from an amide group and a hydroxyl group.

33. The filter cartridge of claim 20, wherein the average pore size of the micro porous membrane is 0.02 μm to 1.0 μm.

34. The filter cartridge of claim 33, wherein the average pore size of the micro porous membrane is 0.02 μm to 0.5 μm.

35. A system for feeding water or a chemical to a microelectronics device fabrication process characterized in that a filter cartridge of claim 15 is incorporated into a water or chemical feed line to the microelectronics device fabrication process.

36. A system for feeding water or a chemical to a microelectronics device fabrication process characterized in that a filter cartridge of claim 19 is incorporated into a water or chemical feed line to the microelectronics device fabrication process.

37. A system for feeding water or a chemical to a microelectronics device fabrication process characterized in that a filter cartridge of claim 20 is incorporated into a water or chemical feed line to the microelectronics device fabrication process.
